(19) United States
(12) Patent Application Publication
(10) Pub. No.: US 2021/0403219 A1
(43) Pub. Date: Dec. 30, 2021

(54) TEMPERATURE REGULATION DEVICE

(71) Applicants: Storm Miller, Orlando, FL (US); Sloan Miller, Boston, MA (US); Mansour AbdulBaki, Marietta, GA (US); Scott Miller, Longboat Key, FL (US)

(72) Inventors: Storm Miller, Orlando, FL (US); Sloan Miller, Boston, MA (US); Mansour AbdulBaki, Marietta, GA (US); Scott Miller, Longboat Key, FL (US)

(21) Appl. No.: 17/355,817

(22) Filed: Jun. 23, 2021

Related U.S. Application Data
(60) Provisional application No. 63/044,272, filed on Jun. 25, 2020.

(51) Int. Cl. B65D 81/18; F25D 5/00

(52) U.S. Cl. CPC B65D 81/18; F24V 30/00; F25D 5/00

(57) ABSTRACT

A nested temperature regulation device includes a watertight pouch having a gas valve, a first plurality of reactive spheres and a rupturable fluid bag. The first reactive spheres are configured to create an endothermic reaction or an exothermic reaction for a set period of time when engaged by the fluid. At least one soluble barrier is positioned within the pouch and includes a hollow interior space that contains another plurality of reactive spheres. Each soluble barrier is constructed to dissolve and to permit the fluid from the bag to engage a subsequent plurality of reactive spheres after a predetermined period of time that is equal to the effective reaction time of the plurality of reactive spheres immediately previously engaged by the fluid. One or more of the plurality of reactive spheres includes a coating that delays the fluid from accessing the reactive material of the sphere having the coating.

### CROSS-REFERENCE TO RELATED APPLICATIONS

This application claims the benefit of U.S. Application Ser. No. 63/044,272 filed on Jun. 25, 2020, the contents of which are incorporated herein by reference.

### TECHNICAL FIELD

The present invention relates generally to temperature regulation devices, and more particularly to a temperature regulation device for prolonged use within a shipping container.

### BACKGROUND

The statements in this section merely provide background information related to the present disclosure and may not constitute prior art.

Within the shipping industry, it is common to send goods that must have their temperature maintained within a specific temperature range. The temperature requirement is found in a number of industries and is based on a number of factors including widespread concerns about safety in the cold food distribution chain, pharmaceutical and life sciences products which must have their temperature maintained to prevent the active ingredients from going bad, sophisticated medical tests which require the shipment of patient specimens to an external laboratory, and/or the increased delivery of products directly to consumers as a result of a telephone or internet order, for example.

For these reasons, there are many known types of temperature regulation devices in use today, each with a wide variation in quality and performance. One of the most common types of temperature regulation devices for containers bearing the types of goods described above is to utilize ice or dry ice to keep a container cold. Another option is to utilize a gel pack which produces an endothermic or exothermic reaction upon being activated.

Although these items are useful for establishing a required temperature for a short period of time (e.g., less than 24 hours), such devices are not well suited for long term temperature regulation wherein items need to remain climate controlled for several days or even weeks. This is because such products are placed within the shipping container at their absolute coldest (or warmest) temperature and immediately begin to degrade at a steady rate over time. As such, once the material completely degrades, it is no longer able to achieve or sustain a target temperature range within the container.

Accordingly, it would be beneficial to provide a temperature regulation device which can establish and maintain an even and controlled temperature for an indefinite period of time so as to not suffer from the drawbacks described above.

### SUMMARY OF THE INVENTION

The present invention is directed to a nested temperature regulation device. One embodiment of the present invention can include a watertight pouch having a first plurality of reactive spheres and a rupturable fluid bag positioned therein. The first reactive spheres are constructed from a material that is configured to create an endothermic reaction or an exothermic reaction for a set period of time when engaged by the fluid stored within the fluid bag.

In one embodiment, at least one soluble barrier is also positioned within the pouch. Each of the soluble barriers including an outer surface and a hollow interior space that contains another plurality of reactive spheres. Each of the soluble barriers being constructed to permit the fluid from the bag to enter the hollow space formed by the respective barrier and to access the plurality of reactive spheres positioned therein after a predetermined period of time.

In one embodiment, the time necessary to penetrate the soluble barrier is equal to the effective reaction time of the plurality of reactive spheres immediately previously engaged by the fluid. In one embodiment, the pouch includes a gas valve for relieving a pressure formed by the endothermic or exothermic reactions.

In various embodiments, one or more of the pluralities of reactive spheres includes a soluble coating that is configured to delay the fluid from accessing the reactive material of the sphere having the coating.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a temperature regulating device that is useful for understanding the inventive concepts disclosed herein.

FIG. 2A is a perspective view of the temperature regulating device in operation, in accordance with one embodiment of the invention.

FIG. 2B is a simplified time and temperature graph depicting the operation of the temperature regulating device shown at FIG. 2A.

FIG. 3A is a perspective view of the temperature regulating device in operation, in accordance with one embodiment of the invention.

FIG. 3B is a simplified time and temperature graph depicting the operation of the temperature regulating device shown at FIG. 3A.

FIG. 4A is a perspective view of the temperature regulating device in operation, in accordance with one embodiment of the invention.

FIG. 4B is a simplified time and temperature graph depicting the operation of the temperature regulating device shown at FIG. 4A.

FIG. 5A is a simplified time and temperature graph depicting an exemplary operation of the temperature regulating device when creating an endothermic reaction.

FIG. 5B is a simplified time and temperature graph depicting an exemplary operation of the temperature regulating device when creating an exothermic reaction.

FIG. 6 is another perspective view of the temperature regulating device in accordance with one embodiment of the invention.

FIG. 7 is a partially exploded view of a reactive sphere for use with the nested temperature regulating device in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the terms “about”, “approximately”, “substantially”, and “generally” shall be used interchangeably to describe a feature, shape, or measurement of a component within a tolerance such as, for example, manufacturing tolerances, measurement tolerances, or the like.

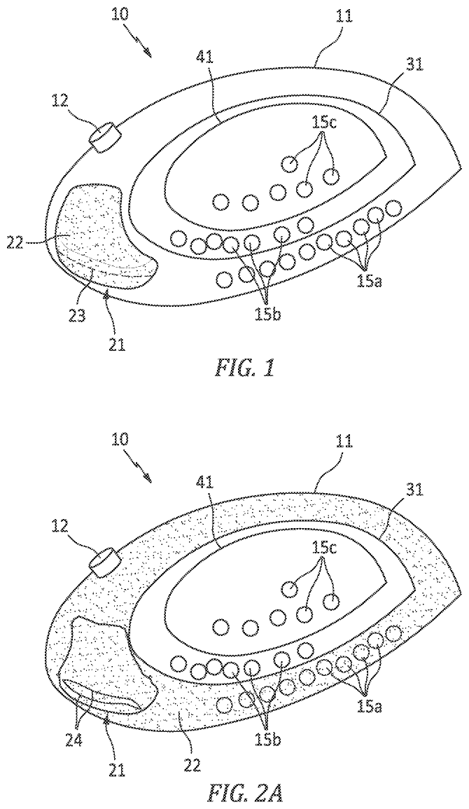

FIGS. 1-7 illustrate various embodiments of a nested temperature regulation device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

Although described for use with a shipping container or other such enclosures for keeping perishable items at a desired temperature, this is but one possible implementation of the inventive concept. To this end, the below described device and/or individual components of the same may be utilized for any number of different purposes and within many different industries where it is desirable to utilize a temperature regulation device capable of generating a sustained temperature for a predetermined period of time.

As shown in FIG. 1, one embodiment of the nested temperature regulation device 10 can include, essentially, an outer pouch 11 that contains a first plurality of reactive spheres 15a, a fluid bag 21, a first soluble barrier 31, a second plurality of reactive spheres 15b, a second soluble barrier 41, and a third plurality of reactive spheres 15c.

The outer pouch 11 can function as a barrier for preventing the internal contents 12-41 from escaping, while allowing heat to be absorbed from or devolved to the contents of the package. In one embodiment, the outer pouch 11 can be constructed from a chemically and physically stable polymer such as high density polyethylene (HDPE), for example, having excellent resistance to breaking and tearing, while also having a high temperature conductive quality.

Although described herein as a pouch, this is but one possible implementation as the component 11 can comprise any number of different shapes and materials suitable for forming an outer body of the device that functions in the manner hereinafter described.

In one embodiment, a gas valve 12 can be provided along the outer pouch 11. In the preferred embodiment, the valve can comprise a one way valve that is permanently connected to, or incorporated into the construction of the pouch 11. In either instance, the valve 12 can function to allow gas created from the below described reactions to escape from within the bag.

In the preferred embodiment, the valve will function to vent gases generated by the below described endothermic or exothermic reactions if/when the pressure within the bag exceeds an ambient pressure of 14.7 psi. Such a feature advantageously ensuring the pouch 11 does not overinflate and rupture during device operation. Of course, other pressures and/or pressure ranges at which the valve can be constructed to operate are also contemplated.

Each of the first, second and third plurality of spheres 15a, 15b, and 15c, respectively, can be constructed from materials chosen so as to have a specific and predictable reaction with the reactive fluid 22 contained in the fluid bag 21, in order to create a desired endothermic or exothermic reaction. In the preferred embodiment, the reactive materials 15a, 15b, and 15c will be compressed into spherical shapes, in accordance with known manufacturing techniques. A spherical shape is preferred as such a shape maximizes the volume to surface area ratio. Because the reaction only happens at the interface between the solid reactants and the fluid, the spherical shape creates a geometrically rate-limiting setup that extends the duration of the cooling or heating reaction as the sphere is consumed from the outside in. Of course, other embodiments are contemplated wherein one or more of the plurality of spheres 15a-15c include a different shape.

In the preferred embodiment, each of the plurality of reactive spheres 15a, 15b, and 15c can be constructed from one or more solid materials chosen from: Barium Hydroxide, sodium bicarbonate, sodium acetate trihydrate, Ammonium Nitrate, Urea, Potassium Chloride, Ammonium Chloride, Thionyl Chloride, Methyl Cellulose, Ethanoic Acid, Ammonium Thiocyanate, Citric acid, Cobalt(II) sulfate heptahydrate, Nacl, and/or Sodium Carbamate, among others, for example. To this end, it is noted that each plurality of spheres 15a, 15b, and 15c may be identical or may be different from the other plurality of spheres in shape, size, weight, and/or construction materials.

The fluid bag 21 can contain a liquid 22 which can interact with the reactive spheres 15a-15c to achieve an endothermic or exothermic reaction. To this end, the fluid bag 21 can be configured in accordance with known manufacturing techniques so as to easily rupture when receiving a compressive or tortional force thereto, in order to release the liquid 22 into the pouch 11. For example, one embodiment of the fluid bag can include a seam 23 that is secured together by a low strength adhesive, which can allow the seam edges 24 to separate when a user squeezes the bag.

As described herein, the fluid 22 positioned within the bag 21 can be any number of different fluids which can be chosen so as to have a specific and predictable reaction with the reactive spheres 15a, 15b, and 15c, in order to generate an endothermic or exothermic reaction. In the preferred embodiment, the fluid will be water, but other embodiments are contemplated wherein the fluid includes, comprises, or consists of any liquid component, medium or catalyst of a selected endothermic or exothermic reaction that would be known to one skilled in the art.

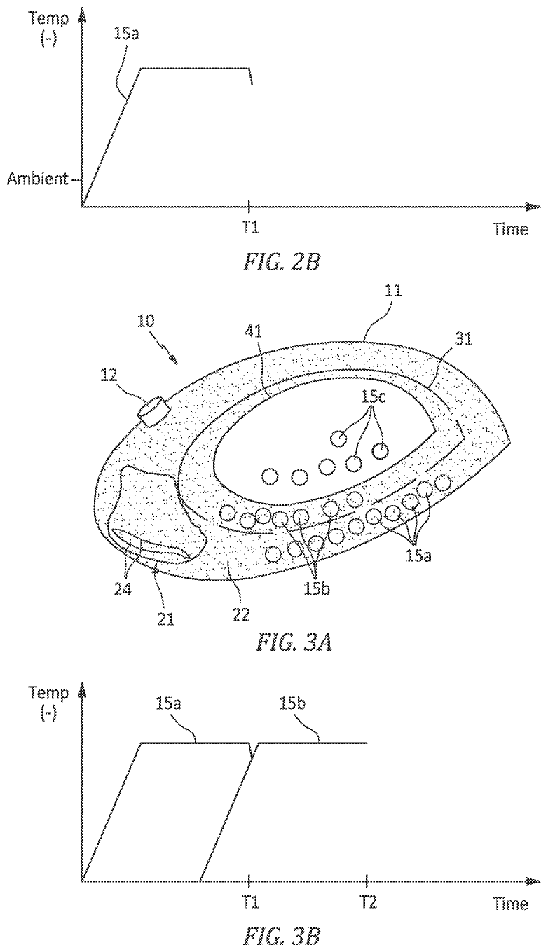

As shown at FIG. 2A, the first plurality of reactive spheres 15a can be positioned within the outer pouch 11 so as to be initially and immediately exposed to the fluid 22 within the pouch 11 upon rupture of the fluid bag 21. As shown at FIG. 2B, this triggers a substantially immediate reaction to produce the desired endothermic or exothermic temperature change for a first period of time t1 before the resultant change begins to dissipate.

The first soluble barrier 31 can be positioned within the pouch 11 and can be sealed so as to encompass the second plurality of reactive spheres 15b, the second soluble barrier 41 and the third plurality of reactive spheres 15c. The first soluble barrier can be constructed to include a shape, size, thickness, and construction material that allows the fluid 22 within the pouch 11 to penetrate the barrier 31 after a predetermined period of time. In the preferred embodiment, the first soluble barrier will be constructed such that the predetermined period of time is the same as t1 wherein the first endothermic/exothermic temperature change begins to dissipate. Of course, any number of other predetermined times are also contemplated.

In one embodiment, the first soluble barrier 31 can be constructed from a water soluble polymer film such as PBAT, PLA, PCL, PBAF, starch-based polymers or blends thereof. One example of a commercially available water soluble barrier for use herein includes model NON02850 1 mil thick liner commercially available by Medline, Inc. Of course, any number of other thicknesses and materials are also contemplated.

As shown at FIG. 3A, the second plurality of reactive spheres 15b will be positioned within the enclosure formed by the barrier 31 so as to be exposed to the fluid 22 as the barrier 31 dissolves. As shown at FIG. 3B, this triggers a substantially immediate reaction to produce the desired endothermic or exothermic temperature change for a second period of time, t2, before beginning to dissipate.

The second soluble barrier 41 can be positioned within the first barrier 31 and can be sealed so as to encompass the third plurality of reactive spheres, 15c. The second soluble barrier can be constructed to include a shape, size, thickness, and construction material so as to allow the fluid 22 within the first barrier 31 to penetrate the barrier 41 after a predetermined period of time.

In the preferred embodiment, the predetermined period of time will be the same as t2 wherein the second endothermic/exothermic temperature change begins to dissipate. The second barrier 41 can be constructed from the same list of materials described above with regard to barrier 31.

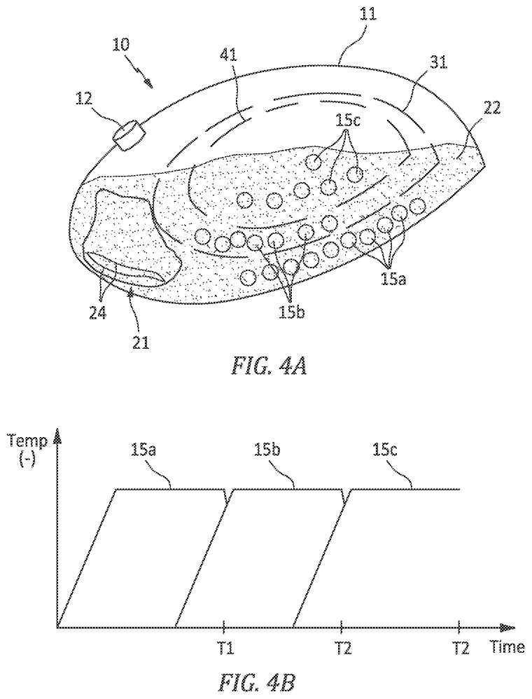

As shown at FIG. 4A, the third plurality of reactive spheres, 15c, will be positioned within the enclosure formed by the barrier 41 so as to be exposed to the fluid 22 as the barrier 41 dissolves. As shown at FIG. 4B, this triggers a substantially immediate reaction to produce the desired endothermic or exothermic temperature change for a third period of time t3 before beginning to dissipate.

As illustrated above, the device 10 works by subsequently accessing nested spheres (e.g., a plurality of spheres within a soluble barrier) over time to allow the device to create and maintain a desired temperature. The timing is designed such that when the immediate previous layer begins to degrade, the next nested layer will be penetrated by the fluid within the device, thereby triggering the next endothermic or exothermic reaction. Each subsequent reaction maintains the target temperature range of the device 10, and the process continues until all layers have been exhausted.

Although the device 10 is described and illustrated above with regard to three nested layers of reactive spheres—15a, 15b, and 15c—separated by two soluble barriers 31 and 41, this is for illustrative purposes only, as any number of additional nested layers can be provided to prolong the operation of the device to any desired timeframe.

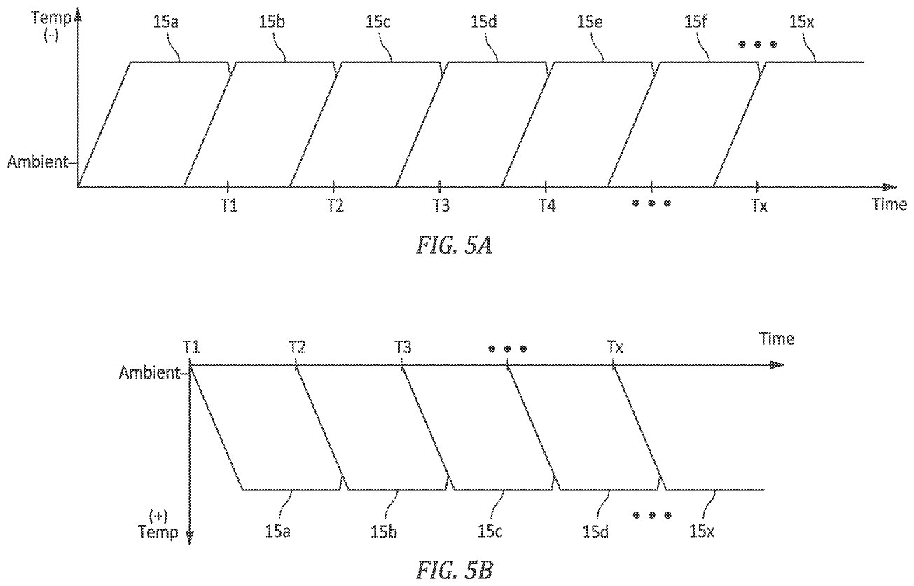

To this end, FIGS. 5A and 5B show that a desired endothermic or exothermic reaction can be generated by the device to achieve a desired temperature output above or below the ambient temperature through the above described interaction between the reactive spheres and the fluid. As such, the total amount of time, tx, for which the achieved temperature output of the device can be sustained is based on the total number of nested layers, 15x.

TABLE 1 below describes the results of an experiment with the device 10 wherein it was desired to achieve an endothermic reaction to create a sustained temperature below the ambient/room temperature for 72 hours. In the experiment, the fluid 22 comprised 400 g of water, and each of the reactive spheres were constructed from a 1 to1 molar ratio of citric acid and sodium bicarbonate, having an average outer diameter of 20.6 mm and an average individual weight of 3.6 g.

TABLE 1

| | | | | Beginning | Final | | |
|---|---|---|---|---|---|---|---|
| | # Reactive | Time from bag | | temperature | temperature | | |
| Nested layer | spheres | (21) break | | of pouch (11) | of pouch (11) | | Elapsed time |
| 1 (e.g., 15a) | 18 | 0 | minutes | 68° F. | 62° | F. | 15.9 hours |
| 2 (e.g., 15b) | 15 | 16.6 | hours | 65.6° F. | 61° | F. | 34.5 hours |
| 3 (e.g., 15c) | 15 | 35.5 | hours | 65.6° F. | 62.4° | F. | 58 hours |
| 4 (e.g., 15d) | 20 | 59 | hours | 63.3° F. | 62.9 | F. | 68 hours |
| 5 (e.g., 15e) | 18 | 71 | hours | 63.8° F. | 62.7° | F. | 80 hours |

In addition to the above, it is also possible to prolong the amount of time some spheres within a nested layer take to activate, in order to increase the overall operational time for each nested layer and the device 10 as a whole. In one embodiment, this can be achieved by providing a coating of physically degradable material along one or more of the reactive spheres that delays the penetration of the fluid 22 that activates the endothermic or exothermic reaction.

In such an embodiment, the reactive spheres can be concentrically coated or layered with a reaction delay layer/coating. Different proportions of the plurality of spheres may be coated with different thicknesses of the coating or with materials with varying rates of decay or solubility. Spheres with different delay coating thicknesses may be combined to provide a composite cooling or heating period that achieves an extended effective delivery time.

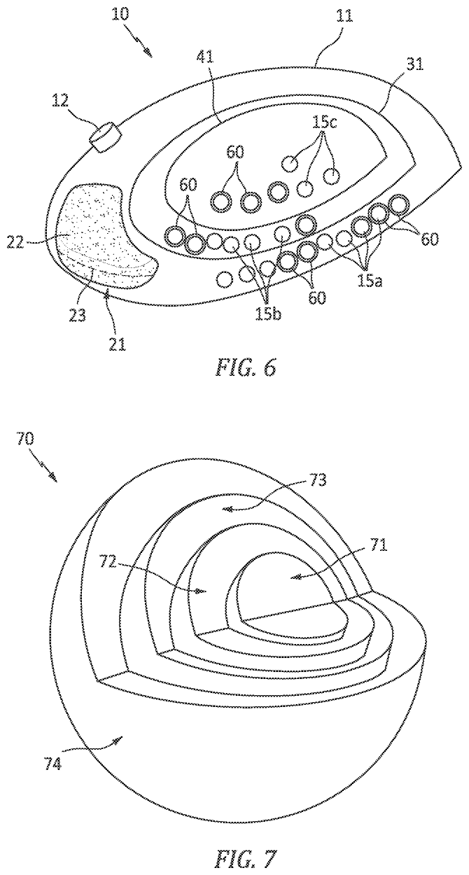

FIG. 6, illustrates one embodiment of the device 10 wherein some of the spheres 15a, 15b, and 15c include an outer coating 60 that is made from a water soluble material. The outer coating can include, comprise, or consist of a wide variety of slowly soluble, insoluble, or swellable substances, particularly polymeric substances which will have a reasonably slow rate of penetration, e.g., solution or swelling in the liquid medium. Thus, the substance is selected to reduce the rate at which the reactive sphere will dissolve.

The coating will also preferably have a low heat of reaction or solution with the fluid 22. Various substances may be selected which have measurable rates of penetration in a fluid 22 such as water or alkaline water. Several nonlimiting examples of suitable materials from which the coating can be constructed include, but are not limited to corn starch, guar gum, hydrophilic gelling polymers, inorganic salts, particularly ammonium salts, more particularly ammonium sulfate and ammonium nitrate, organic materials, such as sugars, e.g. Xylite, and the like.

The coating 60 can be secured to the outer periphery of the reactive spheres in accordance with known processes. One example of a process for constructing a suitable coating and incorporating the same onto a reactive material is described in U.S. Pat. No. 4,780,117, to Lahey, the contents of which are incorporated herein by reference.

Although described above with regard to a single coating, other embodiments are contemplated wherein each reactive sphere can include a layered construction having multiple layers of reactive material and time delay coatings.

For example, FIG. 7 illustrates one embodiment of a reactive sphere 70 that includes a first reactive material 71, a first coating 72, a second reactive material 73 and a second coating 74. Reactive materials 71 and 73 may each be constructed from the same materials and/or processes described above with regard to reactive spheres 15a-15c. Likewise, coatings 72 and 74 may each be constructed from the same materials and/or processes described above with regard to the time delay coating 60.

In either instance, reactive sphere(s) 70 may be constructed to include any number of different layers of materials so as to create a repeatable series of endothermic and/or exothermic reactions. To this end, it is noted that some embodiments are contemplated wherein a single sphere 70 may be configured to initially produce an endothermic reaction, and to conclude with an exothermic reaction when exposed to a fluid, and vice versa.

As described herein, one or more elements of the nested temperature regulation device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting of” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A nested temperature regulation device, comprising:
a watertight pouch having an exterior surface and an interior space;
a first plurality of reactive particles that are disposed within the interior space;
a fluid bag that is disposed within the interior space;
a fluid that is disposed within the fluid bag;
at least one soluble barrier that is disposed within the interior space; and
a second plurality of reactive particles that are disposed within the interior space,
wherein the fluid disposed within the fluid bag is configured to selectively engage each of the first plurality of reactive particles, the at least one soluble barrier, and the second plurality of reactive particles.

2. The device of claim 1, wherein the fluid bag is configured to rupture upon receiving a compressive or torsional force.

3. The device of claim 1, wherein the each of the first plurality of reactive particles, and the second plurality of reactive particles are configured to generate an endothermic reaction upon being engaged by the fluid.

4. The device of claim 1, wherein the each of the first plurality of reactive particles, and the second plurality of reactive particles are configured to generate an exothermic reaction upon being engaged by the fluid.

5. The device of claim 1, further comprising:
a gas valve that is disposed along the pouch.

6. The device of claim 5, wherein the gas valve is configured to remove a pressure created by an interaction between the fluid and the first plurality of reactive particles from the pouch.

7. The device of claim 1, wherein each of the first plurality of reactive particles, and the second plurality of reactive particles are formed into a spherical shape.

8. The device of claim 1, wherein the at least one soluble barrier includes a hollow interior space.

9. The device of claim 8, wherein the second plurality of reactive particles are positioned within the hollow interior space.

10. The device of claim 9, wherein the at least one soluble barrier prevents the fluid from engaging the second plurality of reactive particles for a predetermined period of time.

11. The device of claim 1, wherein the at least one soluble barrier is constructed from at least one of a water soluble polypropylene, a polypropylene film, or a starch-based polymer.

12. The device of claim 1, wherein at least one of the first plurality of reactive particles includes an outer coating.

13. The device of claim 1, wherein each of the first plurality of reactive particles, and the second plurality of reactive particles are constructed from, at least one of: a Barium Hydroxide, a sodium bicarbonate, sodium Acetate trihydrate, an Ammonium Nitrate, a Urea, a Potassium Chloride, an Ammonium Chloride, a Thionyl Chloride, a Methyl Cellulose, an Ethanoic Acid, an Ammonium Thiocyanate, a Citric acid, a Cobalt(II) sulfate heptahydrate, an NaCL, or a Sodium Carbamate.
